(19) United States
(12) Patent Application Publication
(10) Pub. No.: US 2022/0219816 A1
(43) Pub. Date: Jul. 14, 2022

(54) COMPACT INTEGRATED MAST AND CARRIER

(71) Applicant: Bell Textron Inc., Fort Worth, TX (US)

(72) Inventors: Scott David Poster, Arlington, TX (US); Charles Hubert Speller, Flower Mound, TX (US)

(21) Appl. No.: 17/146,123

(22) Filed: Jan. 11, 2021

(51) Int. Cl. B64C 29/00; B64C 27/28; B64C 27/32; B64D 35/00

(52) U.S. Cl. CPC B64C 29/0033; B64D 35/00; B64C 27/32; B64C 27/28

(57) ABSTRACT

There is disclosed in one example a mast assembly for a rotary aircraft, including a single piece mast and carrier, and having a first mechanical interface to mechanically couple to a drive train of the rotary aircraft, and a second mechanical interface to mechanically couple to a rotor assembly.

### TECHNICAL FIELD

This disclosure relates generally to aircraft devices and, more particularly, to a system and method of providing a compact integrated mast and carrier.

### BACKGROUND

Rotary aircraft typically include a mast that holds the rotors aloft from the airframe.

### SUMMARY

In an example, there is disclosed a mast assembly for a rotary aircraft, comprising a single piece mast and carrier, and having a first mechanical interface to mechanically couple to a drive train of the rotary aircraft, and a second mechanical interface to mechanically couple to a rotor assembly.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 is an oblique view of an aircraft with ducted rotors, with the ducted rotors configured for the aircraft to operate in a helicopter mode.

FIG. 2 is an oblique view the aircraft depicted in FIG. 1, with the ducted rotors configured for the aircraft to operate in an airplane mode.

FIG. 3 is a cutaway side view of selected portions of masts that may be used in a conventional rotary aircraft.

FIG. 4 is a side view of a mast assembly.

FIG. 5 illustrates additional aspects of a mast assembly.

FIG. 6 is a flowchart of a manufacturing method.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions may be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In this disclosure, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature) of an element, operations, and/or conditions, the phrase “between X and Y” represents a range that includes X and Y.

Further, as referred to herein in this disclosure, the terms “forward,” “aft,” “inboard,” and “outboard” may be used to describe relative relationship(s) between components and/or spatial orientation of aspect(s) of a component or components. The term “forward” may refer to a special direction that is closer to a front of an aircraft relative to another component or component aspect(s). The term “aft” may refer to a special direction that is closer to a rear of an aircraft relative to another component or component aspect(s). The term “inboard” may refer to a location of a component that is within the fuselage of an aircraft and/or a spatial direction that is closer to or along a centerline of the aircraft relative to another component or component aspect(s), wherein the centerline runs in a between the front and the rear of the aircraft. The term “outboard” may refer to a location of a component that is outside the fuselage-of an aircraft and/or a special direction that farther from the centerline of the aircraft relative to another component or component aspect(s).

Still further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

The mast on a rotary aircraft is typically used to hold the rotors aloft from the airframe. The mast is commonly a two-part construction. The mast itself is a long, cylindrical member that is joined via a spline to a planetary carrier. The planetary carrier engages the driveshaft of the aircraft to impart rotary motion to the mast. The rotor blades are affixed to the top of the mast, and in many rotary aircraft, this provides the primary motive force for the aircraft.

A common mast construction is between approximately 40 and 60 inches tall, and is made from a material such as 4340 steel. Other sizes may include, for example, approximately 29 to 32 inches. Induction hardened surfaces may be used for roller raceways, and sometimes tungsten carbide coated surfaces may be used to create a wear-resistant and durable surface.

It is difficult to harden spline joints because of their complex geometry, so they are commonly left at the core hardness, which is the same as the remainder of the mast. This can lead to spline wear issues.

Typical masts are too tall to fit in commercially available carburization ovens, which excludes the use of carburizing materials such as X53 or 9310 alloyed steel. Thus, induction hardening is generally used, and the spline joint becomes a point of failure.

Torque to the mast is sometimes provided by an epicyclic planetary reduction, which can be of a conventional construction or overhang. These planetary carriers typically utilize a spline joint that must be oil-flushed to prevent fretting and excessive wear.

However, advantages can be realized if a mast is constructed that can be carburized or nitrided, which can allow for specific surfaces to be hardened as needed in a single process. Advantageously, if the mast and carrier are constructed as a single piece, there is no spline joint to fail. Furthermore, if the combination mast and spline is made small enough to fit in a carburization oven, then the entire unit can be baked in a single process. This means that any surfaces that need to be hardened can be treated via a process such as carburization or nitriding.

In this process, the mast and carrier assembly is initially machined from a single piece of material, such as X53, 9310, C64, nitralloy, or some other carburizing or nitriding steel. Because the mast and carrier assembly is machined from a single piece, there is no spline joint. Unhardened areas can then be selected by masking, and the whole piece can then be baked in a carburizing or nitriding oven with a chemical vapor to harden the unmasked areas. In one embodiment, a currently available carburizing oven may accommodate mast constructions of approximately 29 to 32 inches in length. A similar construction could be realized with a conventional mast of approximately 40 to 60 inches, but would require a large carburizing oven that is not presently available.

Thus, a new, larger oven would have to be designed, and in some use cases, this could be cost prohibitive. However, the present specification expressly anticipates embodiments wherein a mast of approximately 40 to approximately 60 inches is made in a single piece with the carrier, and carburized in an oven.

In another embodiment, the mast assembly with an integrated carrier can be much shorter. For example, in the case of a quadcopter, the use of four rotors instead of one may make it possible to have a shorter mast. For example, an embodiment disclosed herein includes a mast assembly with an integrated carrier having an overall length of approximately 14 to 15 inches, or more particularly, approximately 14.5 inches. Because this mast assembly is much shorter than traditional masts, it can be manufactured in a single piece, and can be carburized or nitrided in an oven. Thus, it may be manufactured of a material such as X53, 9310, nitralloy, or some other carburizing or nitriding steel. Furthermore, although there is no spline joint between the carrier and the mast, there may still be a hub spline that mechanically interfaces to the rotors. Advantageously, this hub spline can be carburized along with other hardened parts of the mast. This means that, despite its complex geometry, the hub spline can be hardened to protect against wear. By way of illustrative and nonlimiting example, this design integrates an overhung planetary assembly, which utilizes fewer components than a conventional carrier. The carrier and mast together have an overall length of approximately 14.5 inches. This shorter length of the combination carrier and mast allows for it to fit within the envelope of a carburizing or nitriding oven, and therefore allows the use of materials such as X53, 9310, nitralloy, or some other carburizing or nitriding alloy.

Furthermore, integrating the overhung carrier to the mast is a lighter solution than that of a conventional planetary made from titanium, and utilizes fewer components and fewer joints. This provides a greatly reduced cost.

Advantageously, this construction allows for a hardened hub spline for enhanced wear resistance. It also allows all features that require hardening to be treated with a single process of carburization or nitriding. In one embodiment, a carburized cone seat surface eliminates the expensive process of tungsten carbide coating. Furthermore, incorporating the carrier to the mast eliminates the spline joint, which can fret and wear. This removes the requirement for an oil flush, and removes one potential point of failure in the system.

The foregoing can be used to build or embody several example implementations, according to the teachings of the present specification. Some example implementations are included here as non-limiting illustrations of these teachings.

There is disclosed an example mast assembly for a rotary aircraft, comprising a single piece mast and carrier, and having a first mechanical interface to mechanically couple to a drive train of the rotary aircraft, and a second mechanical interface to mechanically couple to a rotor assembly.

There is further disclosed an example mast assembly, wherein the single piece is steel.

There is further disclosed an example mast assembly, wherein the steel is a carburizing steel.

There is further disclosed an example mast assembly, wherein the carburizing steel is C64.

There is further disclosed an example mast assembly, wherein the carburizing steel is 9310.

There is further disclosed an example mast assembly, wherein the steel is a nitriding steel.

There is further disclosed an example mast assembly, wherein the nitriding steel is nitralloy.

There is further disclosed an example mast assembly, further comprising one or more hardened zones, wherein the zones are hardened according to a chemical vapor heat treating process.

There is further disclosed an example mast assembly, wherein the process is carburization.

There is further disclosed an example mast assembly, wherein the process is nitridization.

There is further disclosed an example mast assembly, wherein the second mechanical interface comprises a hardened spline, wherein the hardened spline is carburized or nitrided.

There is further disclosed an example mast assembly, wherein the mast assembly has a length of between about 14 inches and about 16 inches.

There is further disclosed an example mast assembly, wherein the mast assembly has a length of less than approximately 32 inches.

There is also disclosed an example rotary aircraft, comprising: an airframe; a drivetrain; a rotor assembly; and an integrated mast assembly to mechanically couple the drivetrain to the rotor assembly, the integrated mast assembly comprising a single machined part including a mast and a carrier.

There is further disclosed an example rotary aircraft, wherein the aircraft is a quadcopter.

There is further disclosed an example rotary aircraft, wherein the aircraft is autonomous or semi-autonomous.

There is further disclosed an example rotary aircraft, wherein the single machined part is steel.

There is further disclosed an example rotary aircraft, wherein the steel is a carburizing steel.

There is further disclosed an example rotary aircraft, wherein the carburizing steel is C64.

There is further disclosed an example rotary aircraft, wherein the carburizing steel is 9310.

There is further disclosed an example rotary aircraft, wherein the steel is a nitriding steel.

There is further disclosed an example rotary aircraft, wherein the nitriding steel is nitralloy.

There is further disclosed an example rotary aircraft, wherein the single machined part further comprises one or more hardened zones, wherein the zones are hardened according to a chemical vapor heat treating process.

There is further disclosed an example rotary aircraft, wherein the process is carburization.

There is further disclosed an example rotary aircraft, wherein the process is nitridization.

There is further disclosed an example rotary aircraft, wherein the single machined part is configured to mechanically couple to a hardened spline, wherein the hardened spline is carburized or nitrided.

There is further disclosed an example rotary aircraft, wherein the integrated mast assembly has a length of between about 14 inches and about 16 inches.

There is further disclosed an example rotary aircraft, wherein the integrated mast assembly has a length of less than approximately 32 inches.

There is also disclosed an example manufacturing method, comprising: machining, from a single metal block, an integrated mast and carrier for a rotary aircraft; and heating the integrated mast and carrier in the presence of a hardening chemical vapor.

There is further disclosed an example method, further comprising masking a portion of the integrated mast and carrier not to be hardened.

There is further disclosed an example method, wherein the single metal block is steel.

There is further disclosed an example method, wherein the steel is a carburizing steel.

There is further disclosed an example method, wherein the carburizing steel is C64.

There is further disclosed an example method, wherein the carburizing steel is 9310.

There is further disclosed an example method, wherein the steel is a nitriding steel.

There is further disclosed an example method, wherein the nitriding steel is nitralloy.

There is further disclosed an example method, further comprising hardening one or more zones according to a chemical vapor heat treating process.

There is further disclosed an example method, wherein the process is carburization.

There is further disclosed an example method, wherein the process is nitridization.

There is further disclosed an example method, further comprising hardening a spline via carburization or nitridization.

There is further disclosed an example method, wherein the integrated mast and carrier has a length of between about 14 inches and about 16 inches.

There is further disclosed an example method, wherein the integrated mast and carrier has a length of less than approximately 32 inches.

A system and method for providing a compact integrated mast and carrier will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

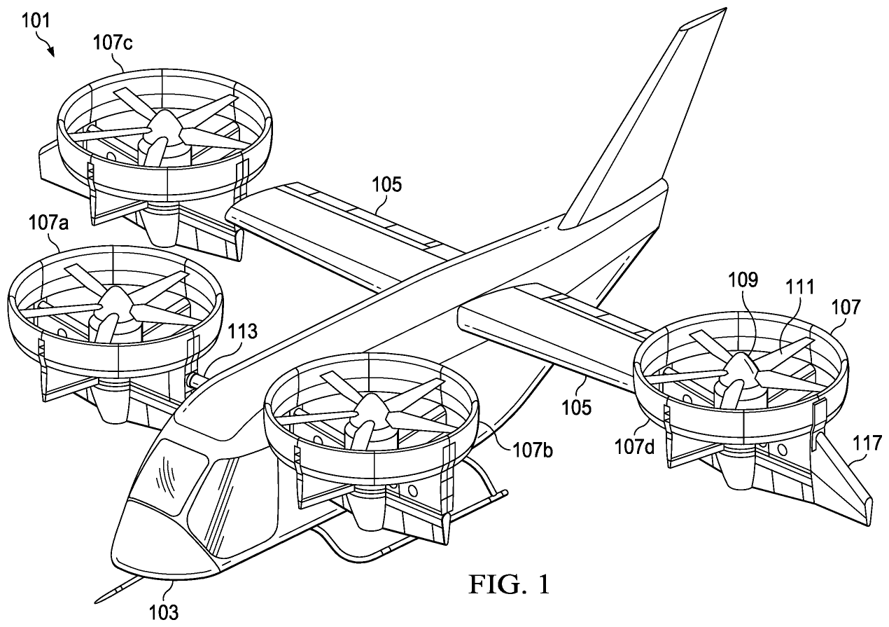

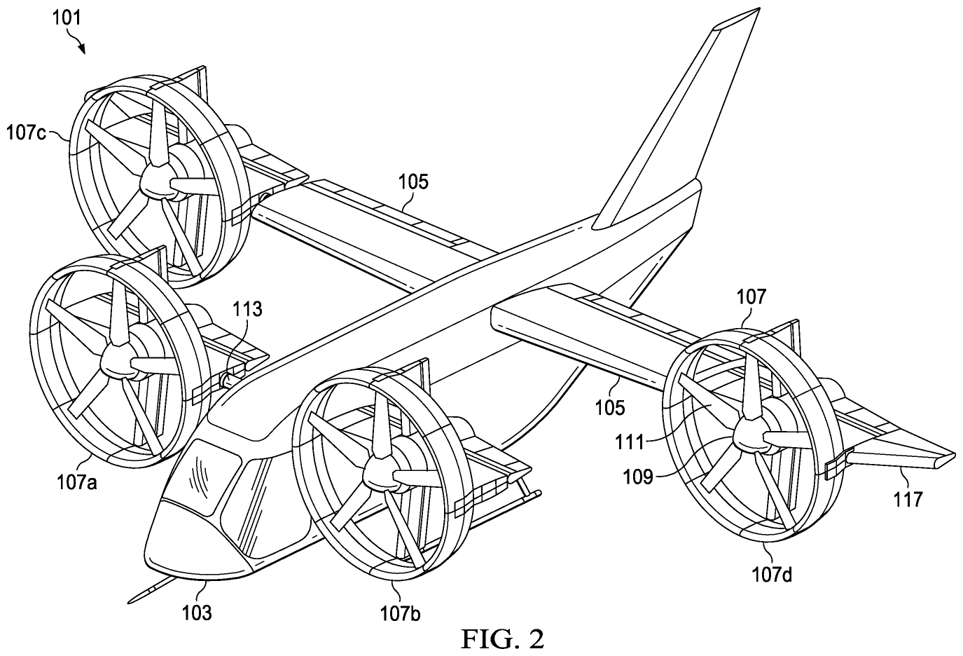

FIGS. 1 and 2 are oblique views of a ducted-rotor aircraft 101. Aircraft 101 comprises a fuselage 103 with a fixed wing 105 that extends therefrom and a plurality of rotatable ducts 107. Each duct 107 houses a power plant for driving an attached rotor 109 in rotation. Each rotor 109 has a plurality of blades 111 configured to rotate within ducts 107.

The position of ducts 107, and optionally the pitch of blades 111, can be selectively controlled to control direction, thrust, and lift of rotors 109. For example, ducts 107 are repositionable to convert aircraft 101 between a helicopter mode and an airplane mode. As shown in FIG. 1, ducts 107 are positioned such that aircraft 101 is in helicopter mode, which allows for vertical takeoff and landing, hovering, and low-speed directional movement. As shown in FIG. 2, ducts 107 are positioned such that aircraft 101 is in airplane mode, which allows for high-speed forward-flight.

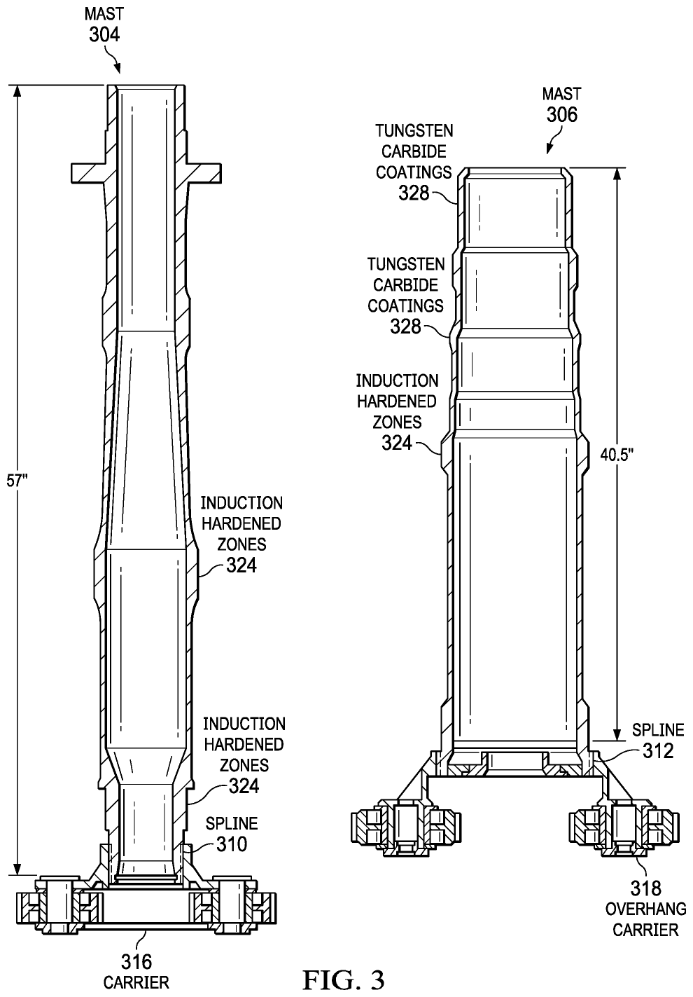

In this embodiment, aircraft 101 is configured with four ducts 107, including two ducts 107a and 107b that form a forward pair of ducts and two ducts 107c and 107d that form an aft pair of ducts. Each duct 107 is rotatably coupled to fuselage 103 of aircraft 101 via a spindle. Ducts 107a and 107b are coupled directly to fuselage 103 by a first spindle 113. Ducts 107c and 107d are each independently coupled to a corresponding end of wing 105 via a respective spindle 115 (e.g., as seen in FIG. 3). As shown, ducts 107c and 107d each include a winglet 117 that is coupled thereto. It should be appreciated that aircraft 101 is not limited to the illustrated configuration having four ducts 107, and that aircraft 101 may alternatively be implemented with more or fewer ducts 107. Furthermore, it should be appreciated that the teachings of the present specification may be applicable to other types of aircraft, including traditional helicopters, military helicopters such as attack helicopters, and fixed-wing aircraft, by way of example.

In an illustrative use case, aircraft 101 could be an “air taxi,” which provides for example short point-to-point flights for customers. When operating as an air taxi, aircraft 101 could be piloted or unpiloted. For example, aircraft 101 could be an unmanned aerial vehicle (UAV) that provides air taxi service. In cases where aircraft 101 is piloted, the flight controls may be highly augmented, for example in a “fly by wire” configuration. In some cases, instead of a traditional stick, collective, and pedals, aircraft 101 could provide an inceptor, which simplifies pilot control, and leaves many of the more detailed flight commands to a flight control computer. Furthermore, in cases where aircraft 101 is piloted, it may also provide an autopilot mode, wherein for certain legs of a flight, a flight path is programmed and the aircraft acts autonomously for the duration of that flight path until the leg is finished, or the pilot overrides the autopilot.

FIG. 3 is a cutaway side view of selected portions of masts that may be used in a conventional rotary aircraft. In this case, mast 304 is approximately 57 inches tall, while mast 306 is approximately 40.5 inches tall.

Mast 304 couples to a carrier 316. Carrier 316 couples to a primary driveshaft of the rotary aircraft. Via spline 310, carrier 316 imparts rotary motion to mast 304. Rotor blades couple to mast 304 at the top, and thus provide motion for the aircraft.

Similarly, mast 306 is approximately 40.5 inches in length. In this case, mast 306 couples to an overhang carrier 318. Overhang carrier 318 mechanically couples to a driveshaft of the rotary aircraft to receive rotary motion. Overhang carrier 318 couples to mast 306 at a spline 312.

Masts 304, 306 may typically be made of a material such as 4340 steel. Because masts 304, 306 are too large to fit in commercially available carburizing ovens, they are generally not subjected to a carburizing process. Instead, certain induction hardened zones 324 may be selected for induction hardening. This provides hardening to protect from wear for contact parts, which receive a higher wear than other portions. However, the complex geometry of spline 310, 312 makes it difficult to induction harden these. Thus, while the overall construction may be subjected to a chemical hardening process, splines 310, 312 are not hardened relative to the rest of the construction. In some cases, the spline joint must be continuously oil flushed to prevent fretting and excessive wear.

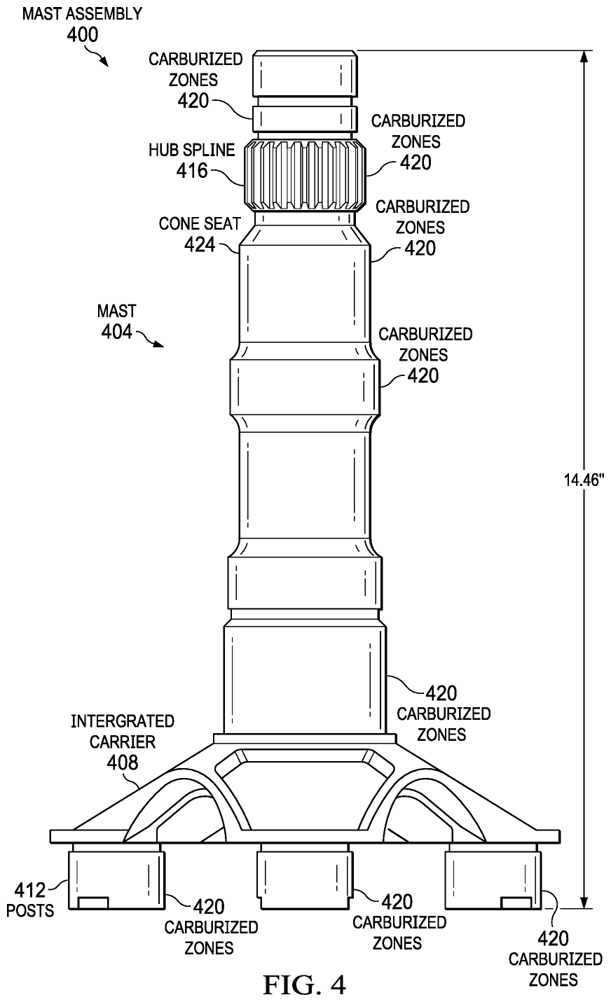

FIG. 4 is a side view of a mast assembly 400. Mast assembly 400 includes a mast 404 and an integrated carrier 408. Mast 404 and integrated carrier 408 may be machined from a single piece of metal, such as X53, 9310, or some other material. In some embodiments, the material may be a carburizing or nitriding steel.

In one embodiment, mast assembly 400 has an overall length of approximately 14.46 inches. This means that its size is conducive to commercially available carburizing ovens. Thus, rather than using tungsten carbide coating or induction hardening, mast assembly 400 can be carburized. This can include masking off parts of mast assembly 400 that do not need to be carburized, and then baking mast assembly 400 in an oven with a carbon vapor. A similar process can be used for nitriding.

In this example, several carburized zones 420 are identified that may receive wear. Because it is desirable to harden these areas, they may be subjected to the carburizing process. These include, for example, cone seat 424, integrated posts 412, and other features on mast assembly 400. Furthermore, a hub spline 416 is provided to mechanically engage the rotors. Hub spline 416 has a complex geometry that would normally preclude induction hardening or tungsten carbide coating. However, hub spline 416 is subject to carburizing or nitriding. Thus, hub spline 416 can be hardened in the same single process that hardens other portions of mast assembly 400.

Mast assembly 400 may be machined from a single piece of steel, rather than from multiple pieces.

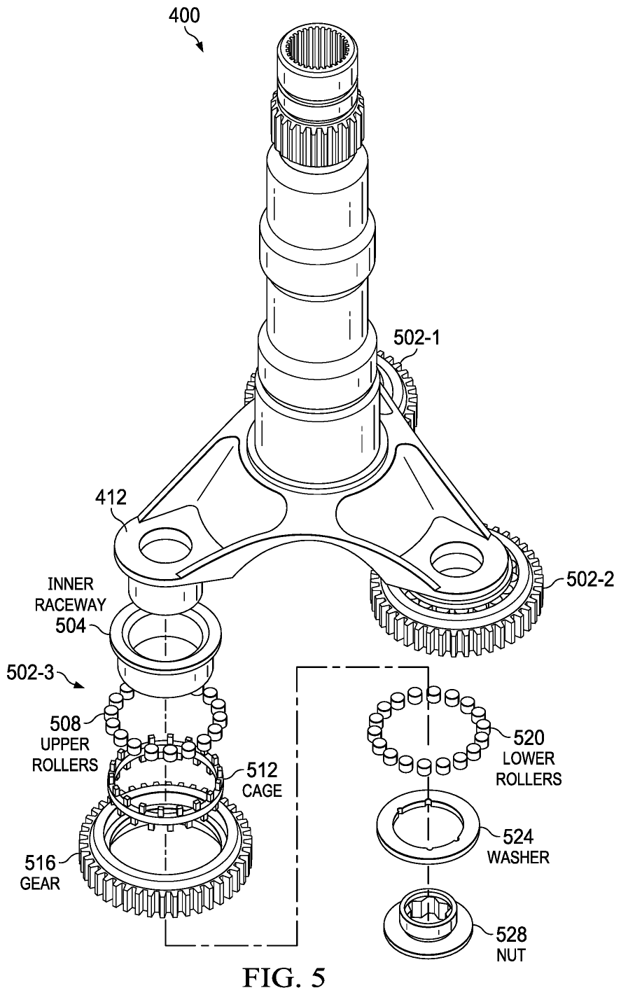

FIG. 5 illustrates additional aspects of mast assembly 400. In particular, mast assembly 400 engages a large outer gear (not shown), which may be a stationary gear. This permits rotary motion of mast assembly 400, relative to the airframe. This large outer gear is sometimes referred to as a sun gear.

In this example, mast assembly 400 includes three gear assemblies 502-1, 502-2, and 502-3.

As illustrated with respect to gear assembly 502-3, the gear assembly engages an inner raceway 504, upper rollers 508, cage 512, gear 516, lower rollers 520, washer 524, and a nut 528 which holds the assembly together. In this example, these are not manufactured as a single piece with mast assembly 400, because it would be difficult to provide the rotary motion if they were manufactured as a single piece. Gear assemblies 502 engage an outer gear, and the outer gear can engage the main driveshaft of the aircraft. This provides motive force to the rotary aircraft.

In an example use case, such as in aircraft 101 of FIG. 1, four mast assemblies 400 may be provided. The four mast assemblies are substantially similar, although to maintain stable flight, they do not all turn the same direction.

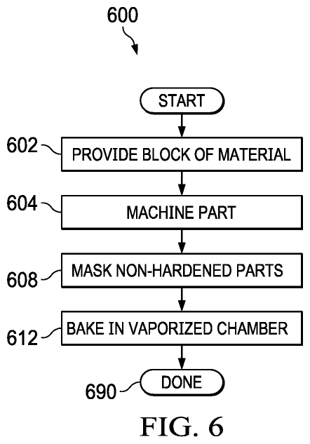

FIG. 6 is a flowchart of a method 600. Method 600 may be used to manufacture a mast assembly with an integrated mast and carrier, as described herein.

Beginning in block 602, the manufacturer provides a block material. This could be, for example, a block of metal such as steel, including a carburizing or nitriding steel. The steel could include, for example, C64, 9310, or a nitriding steel such as nitralloy.

In block 604, from this single block of steel, the manufacturer machines the part down to the shape and dimensions of the desired integrated mast. As disclosed in previous FIGURES, this includes both a mast assembly and carrier assembly that are machined from the same block of steel.

In block 608, the manufacturer masks off parts of the mast assembly that are not to be hardened. Parts that are to be hardened may be left unmasked.

In block 612, the manufacturer bakes the mast assembly in a vaporized chamber. Within the chamber, the manufacturer may introduce appropriate vapor, such as carbon vapor or nitrogen vapor, to carburize or nitride the steel as desired. Advantageously, because the machined part is of an appropriate size, it may be possible to bake it in a commercially available carburizing machine, rather than needing to design and manufacture a much larger machine at great expense. During the bake process of block 612, the unmasked parts of the machined part become hardened by having the carbon or nitrogen vapor infuse into the steel substrate. Once the baking is done, the masking may be removed, and the part may be ready for further processing and/or assembly.

In block 690, the method is done.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes 2, 3, 4, et cetera; greater than 0.10 includes 0.11, 0.12, 0.13, et cetera). For example, whenever a numerical range with a lower limit, R₁, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. Also, the phrases “at least one of A, B, and C” and “A and/or B and/or C” should each be interpreted to include only A, only B, only C, or any combination of A, B, and C.

The diagrams in the FIGURES illustrate the architecture, functionality, and operation of possible implementations of various embodiments of the present disclosure. It should also be noted that, in some alternative implementations, the function(s) associated with a particular block may occur out of the order specified in the FIGURES. For example, two blocks shown in succession may, in fact, be executed substantially concurrently, or the blocks may sometimes be executed in the reverse order or alternative orders, depending upon the functionality involved.

The embodiments described throughout this disclosure provide numerous technical advantages, including by way of example, maintaining performance at high angles of attack while increasing performance at low angles of attack.

Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment,” “example embodiment,” “an embodiment,” “another embodiment,” “certain embodiments,” “some embodiments,” “various embodiments,” “other embodiments,” “alternative embodiment,” and the like are intended to mean that any such features are included in one or more embodiments of the present disclosure, but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z,” “at least one of X, Y or Z,” “one or more of X, Y and Z,” “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., element, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A mast assembly for a rotary aircraft, comprising a single piece mast and carrier, and having a first mechanical interface to mechanically couple to a drive train of the rotary aircraft, and a second mechanical interface to mechanically couple to a rotor assembly.

2. The mast assembly of claim 1, wherein the single piece is steel.

3. The mast assembly of claim 2, wherein the steel is a carburizing steel.

4. The mast assembly of claim 3, wherein the carburizing steel is C64.

5. The mast assembly of claim 3, wherein the carburizing steel is 9310.

6. The mast assembly of claim 2, wherein the steel is a nitriding steel.

7. The mast assembly of claim 6, wherein the nitriding steel is nitralloy.

8. The mast assembly of claim 2, further comprising one or more hardened zones, wherein the zones are hardened according to a chemical vapor heat treating process.

9. The mast assembly of claim 8, wherein the process is carburization.

10. The mast assembly of claim 8, wherein the process is nitridization.

11. The mast assembly of claim 2, wherein the second mechanical interface comprises a hardened spline, wherein the hardened spline is carburized or nitrided.

12. The mast assembly of claim 1, wherein the mast assembly has a length of between about 14 inches and about 16 inches.

13. The mast assembly of claim 1, wherein the mast assembly has a length of less than approximately 32 inches.

14. A rotary aircraft, comprising:
an airframe;
a drivetrain;
a rotor assembly; and
an integrated mast assembly to mechanically couple the drivetrain to the rotor assembly, the integrated mast assembly comprising a single machined part including a mast and a carrier.

15. The rotary aircraft of claim 14, wherein the aircraft is a quadcopter.

16. The rotary aircraft of claim 14, wherein the aircraft is autonomous or semi-autonomous.

17. The rotary aircraft of claim 14, wherein the single machined part is steel.

18. A manufacturing method, comprising:
machining, from a single metal block, an integrated mast and carrier for a rotary aircraft; and
heating the integrated mast and carrier in the presence of a hardening chemical vapor.

19. The method of claim 18, further comprising masking a portion of the integrated mast and carrier not to be hardened.

20. The method of claim 18, wherein the single metal block is a carburizing or nitriding steel.
